(19) United States
(12) Patent Application Publication
(10) Pub. No.: US 2019/0243519 A1
(43) Pub. Date: Aug. 8, 2019

(54) SCROLLING SITE SEARCH RESULTS DISPLAY

(71) Applicant: Deals Publications Inc., Sioux Falls, SD (US)

(72) Inventors: Robert J. Nelson, Sioux Falls, SD (US); Jarrod W. Page, Brandon, SD (US); Don S. Nelson, Sioux Falls, SD (US)

(73) Assignee: Deals Publications Inc., Sioux Falls, SD (US)

(21) Appl. No.: 15/891,226

(22) Filed: Feb. 7, 2018

(51) Int. Cl. G06F 3/0485; G06F 17/30; G06F 3/0482

(52) U.S. Cl. CPC G06F 3/0485; G06F 3/0482; G06F 17/30867

(57) ABSTRACT

This disclosure describes a scrolling graphical user interface element that displays, in real time or substantially real time, search requests that are received by a system. For example, when a query is received, details about the query are stored and subsequently used to generate a selectable item that is provided on the scrolling graphical user interface element. The scrollable graphical user interface is provided on a webpage and is updated with selectable items each time a new query is received. Thus, any user accessing the webpage can view, in real time or substantially real time, other queries that are being submitted by other users.

### BACKGROUND

Performing a search typically entails enabling a user to access a particular webpage, enabling the user to enter a search term into a text field on the webpage, and returning various search results. In some cases, when the various search results are returned, they are ordered in terms of relevance, popularity or what is currently trending in the subject area for which the search was submitted. However, the returned results are typically static in that the relevance of the results are based on when the search was actually submitted. Further, the user is only provided information associated with the search term they provided.

It is with respect to these and other general considerations that examples have been described. Also, although relatively specific problems have been discussed, it should be understood that the examples should not be limited to solving the specific problems identified in the background.

### SUMMARY

This disclosure generally relates to a graphical user interface element for a user interface that displays a number of different search queries in real time or substantially real time. For example, a user may navigate to a particular website and enter a query. A search is performed on one or more terms in the query and the results are provided to the individual that submitted the query. However, in addition to the results, the webpage may be configured to display a scrolling graphical user interface element. The scrolling graphical user interface element may show the query that the individual just submitted as well as other queries that were submitted by other individuals in real time or substantially real time. In some implementations, each item that is displayed on the scrolling graphical user interface element may be selectable. When a particular item in the scrolling graphical user interface element is selected, the same or a similar search (that caused the item to be displayed in the scrolling graphical user interface element) is performed and corresponding results are returned to the individual that selected the item.

Accordingly, described herein is a method that includes receiving, in a search box associated with a webpage, input corresponding to a query to be performed and storing one or more details associated with the query. A search using the received input is then performed. A scrolling graphical user interface element is then generated or otherwise updated to include an item that is associated with the query. The scrolling graphical user interface element displays, in substantially real time, the item along with one or more additional items that are each associated with one or more other query requests. The results of the query and the scrolling graphical user interface element are then provided in a graphical user interface of the webpage.

Also described is a system that includes a processing unit and a memory for storing instructions that, when executed by the processing unit, perform a method for displaying a scrolling graphical user interface element. This method includes receiving input corresponding to a query to be performed and storing one or more details of the query. A search is performed, using the received input, to determine a result of the query. A scrolling graphical user interface element is then generated or otherwise updated. The scrolling graphical user interface element displays, in substantially real time, a selectable item that is associated with the input, along with one or more additional selectable items. In some examples, each of the one or more additional selectable items is associated with one or more other received query requests. The selectable item is also associated with the one or more details of the query. The result of the query and the scrolling graphical user interface element is then provided in a graphical user interface of a webpage.

The present disclosure also describes a user interface for a computing device. The user interface includes a first portion for receiving one or more details of a query, a second portion that displays results of the query, and a third portion. The third portion includes a scrolling graphical user interface element that displays, in substantially real time, a plurality of selectable items. In some cases, each of the plurality of selectable items is associated with one or more queries that were received from one or more other computing devices.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a system for generating a scrolling graphical user interface element in response to a received query according to an example.

FIG. 1B illustrates the system of FIG. 1A in which the scrolling graphical user interface element is provided to one or more computing devices according to an example.

FIG. 2 illustrates an example user interface of a webpage that includes a scrolling graphical user interface element and is also configured to receive a query according to an example.

FIG. 3 illustrates a user interface that displays the results of a search along with the scrolling graphical user interface element according to an example.

FIG. 4 illustrates another user interface of a webpage that displays a scrolling graphical user interface element according to an example.

FIG. 5 illustrates an example user interface of a webpage that shows search results in response to an individual selecting one of the items that is displayed in the scrolling graphical user interface according to an example.

FIG. 6 illustrates another example of a scrolling graphical user interface element for a webpage according to an example.

FIG. 7 illustrates a method for generating and/or updating a scrolling graphical user interface element according to an example.

FIG. 8 illustrates a method for performing a search in response to an item in a graphical user interface element being selected according to an example.

FIG. 9 illustrates example physical components of a computing device with which aspects of the disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

This application describes a scrolling graphical user interface element for a graphical user interface. The scrolling graphical user interface element displays a number of different selectable items that are associated with received search queries. In some examples, the search queries have been received by other individuals that have provided one or more queries in a graphical user interface of a webpage or an application that is executing on a computing device. When a query is received, the scrolling graphical user interface element is updated to show selectable items that are associated with each received query—in some cases, regardless of the location of individual that submitted the query. The items are displayed in real time or substantially real time.

As used herein, the term scrolling means to move from a first position in the graphical user interface element to a second position. The movement may be in any direction (e.g., up, down, across or any combination thereof). In some examples, the movement may be a continuous motion. In other examples, there may be a predetermined or specified delay as the item moves from a first position to a second position. In yet other examples, each item is moved from a first position to a second position each time a new query is received.

Although scrolling is specifically mentioned, the graphical user interface element may be updated, generated or otherwise configured to show any number items associated with received search terms or queries and the movement of these items is not necessarily limited to scrolling. For example, the graphical user interface element may cause search terms to fade in or out after a predetermined amount of time has elapsed or in response to a received query. In other cases, items may occupy a particular position or spot on the graphical user interface element and may be replaced by other search terms or queries as they are received. In yet other examples, queries that are currently trending or popular may be placed in various orders on the graphical user interface element based, at least in part, on the current popularity of the query.

As will be described below, the scrolling graphical user interface element may be part of or otherwise integrated with a particular webpage or other user interface of a computing device. For example, an individual may use a computing device to navigate to a particular website or access a particular application and enter a query in a search box that is provided.

A search is then performed using one or more terms in the query. The results are provided to the individual that submitted the query. In addition to displaying the results, the webpage or application may also display a scrolling graphical user interface element that lists or otherwise displays other searches that have been submitted by other individuals. As these items are displayed on the scrolling graphical user interface element, an individual may select one of the displayed items. A similar search, using the search terms associated with the displayed item, may then be performed.

Thus, unlike other search mechanisms that simply display results of a search, the graphical user interface element of the present disclosure provides results of a particular user's search, as well as other searches or queries that are occurring simultaneously or substantially simultaneously and/or that have occurred in the past. As such, as the individual is reviewing his own search results, the individual may also see information about other searches that are occurring and/or have occurred. As a result, one or more items in the scrolling graphical user interface element may pique the individual's interest cause the individual to perform additional searches (e.g., by causing the user to select one or more of the items in the graphical user interface element).

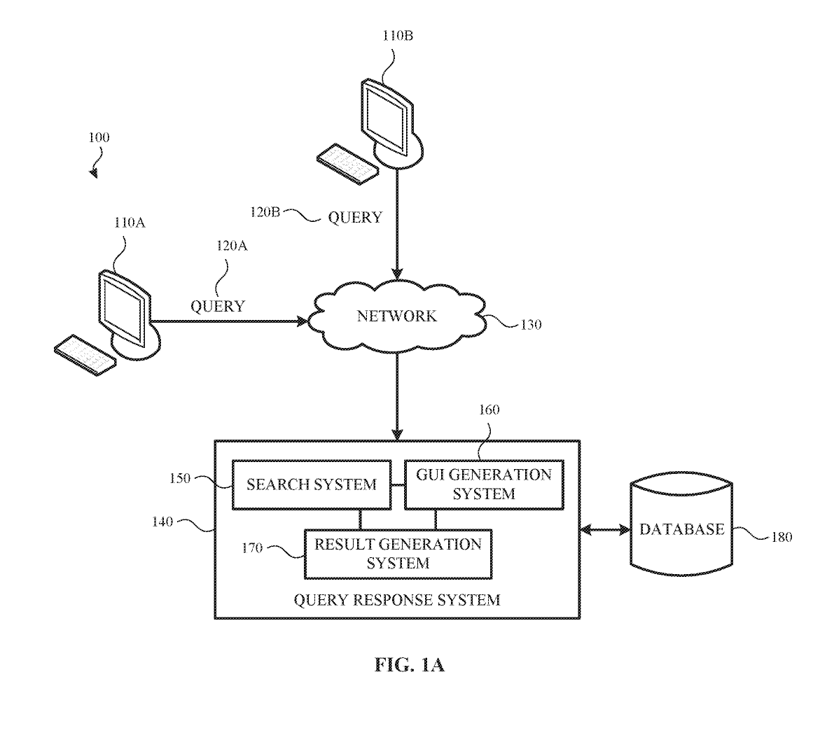

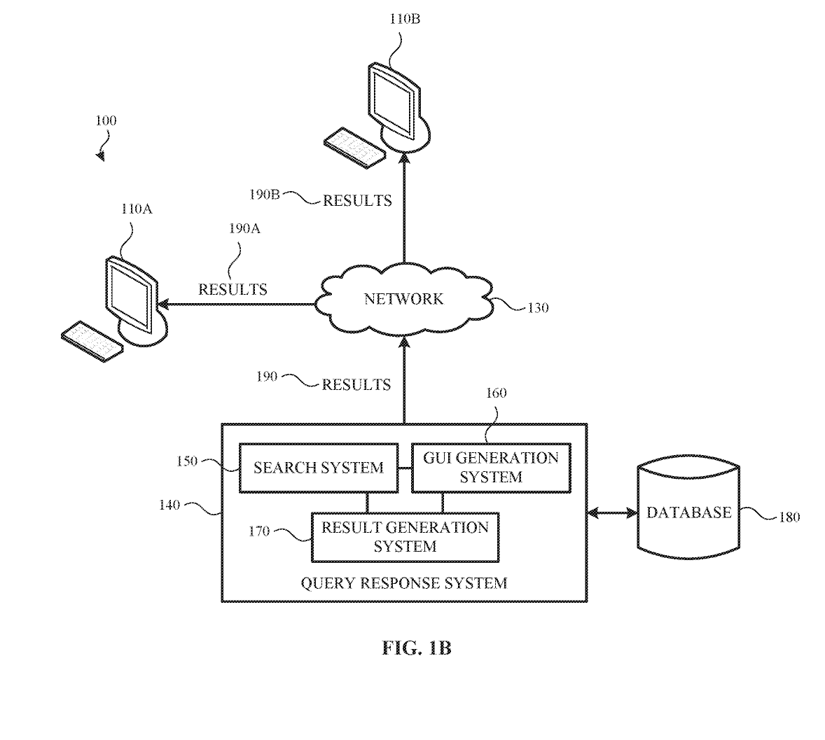

These and other examples will be described in more detail below with respect to FIG. 1A-FIG. 8.

FIG. 1A illustrates a system 100 for generating a scrolling graphical user interface element according to an example. The scrolling graphical user interface element may be displayed in a graphical user interface associated with a webpage, an application, a search engine or other display associated with a computing device. As will be described below, the scrolling graphical user interface element may display, in real time or substantially real time, one or more selectable items that indicate one or more searches that have been executed on a particular website, search engine or a particular application.

In some examples, the system 100 may include a first computing device 110A and a second computing device 110B. Although two computing devices are shown, the system 100 may include any number of computing devices. In some examples, the computing devices may be laptop computers, desktop computers, tablet computing devices, wearable computing devices, gaming machines, mobile phones and the like.

Each computing device may be configured to execute one or more applications and/or access one or more websites that allows an individual to submit a query (e.g., query 120A or query 120B) over a network 130 to a query response system 140. In the examples provided in this application, the query response system 140 is a part of or is otherwise associated with a website that lists various automobiles for sale. However, although specific examples are provided, the scrolling graphical user interface element that is generated by the query response system 140 may be provided on any user interface that allows an individual to submit a query. As discussed above, these user interfaces include search engines, websites, applications and the like.

Continuing with the example above, a first individual may use the first computing device 110A to access a website (e.g., www.auta.com) and submit a query 120A about a particular automobile. In this example, the query 120A received from the first individual is a query for “Tesla.” When the query 120A is submitted, it is sent from the first computing device 110A to the query response system 140 over the network 130. Likewise, a second individual may use the second computing device 110B to access the same website and submit a second query (e.g., query 120B). In the examples that follow, the second query 120B is a query for “4Runner.”

Like the first query 120A, the second query 120B is also provided to the query response system 140 over the network 130. In some cases, each of the queries may be submitted simultaneously or substantially simultaneously. In other cases, each of the queries may be submitted at different times.

When the query response system 140 receives each query, each of the queries is provided to a search system 150 associated with the query response system 140. In some examples, the search system 150 determines one or more search terms contained in the query, determines other information associated with each query and/or determines the context of each query. The information about each query may include a location from which each query originated, information about the particular individual that submitted the query (e.g., profile information associated with the individual that accesses the query response system 140) and so on.

Once the search terms, the context of the query, and/or other information about the query is determined, this information is provided to and stored in a database 180 or other storage device. In some cases, the database 180 may be part of the query response system 140. In other cases, the database 180 may be remote from, but accessible by the query response system 140 (e.g., over a network connection). In some other cases, the database 180 may only be accessible to individuals that access a particular website. That is, the database 180 may only have information that an administrator or owner of the particular website allows to be stored in the database 180. In yet other cases, the query response system 140 may query various sources (e.g., over a network connection) for information associated with the query.

The search system 150 may also access the database 180 and perform a search for content associated with the query. For example, if the search system 150 receives query 120A of “Tesla”, the search system 150 will search the database 180 for content or information about Teslas. Likewise, if the search system 150 receives the query 120B of “4Runner”, the search system 150 will search the database 180 for information about 4Runners.

Once the search has been performed, a result generation system 160 compiles the results of the search. In some cases, the results of the search may be organized according to a number of different factors. For example, if the search was for automobiles, the results may be organized based on price, distance from the individual that submitted the query, year, mileage and so on.

As shown in FIG. 1A, the query response system 140 also includes a graphical user interface (GUI) generation system 160. The GUI generation system 160 generates and/or updates a scrolling graphical user interface element that displays various queries that have been submitted to the query response system 140. The particular website that is associated with the query response system 140 may then display the scrolling graphical user interface element.

For example, when the query response system 140 receives the query of “Tesla”, the GUI generation system 160 generates or otherwise updates the scrolling graphical user interface element to include a “Tesla” item. The scrolling user interface element is provided to each computing device and individual that accesses the website. As such, the Tesla item on the scrolling graphical user interface is provided to all individuals. Likewise, when the query response system 140 receives the query of “4Runner”, the GUI generation system 160 generates a 4Runner item or otherwise updates the scrolling graphical user interface element to include a 4Runner item.

The GUI generation system 160 may be configured to format the scrolling graphical user interface element in a manner that makes the content displayed on the user interface readable. In some instances, this includes formatting the user interface, or portions of the user interface, such that the scrolling graphical user interface element is prominently displayed or otherwise fits on the graphical user interface regardless of the size of the display on which it is presented.

The GUI generation system 160 may also be configured to provide a time indication associated with each item. In some instances, the time indication may provide information about when the query was received or when the database was searched. The time indication may be a time of day or an amount of time that has passed since the query was received. In other cases, the scrolling graphical user interface may include an indication of the number of times the same or a similar search has been executed over a specified amount of time (e.g., a query for 4Runners has been received ten times over the past hour).

Once the GUI generation system 160 has generated or updated the scrolling graphical user interface element, the results 190 of the search, along with the updated scrolling graphical user interface element may be provided to each computing device. That is, the first computing device 110A may receive results 190A that provide information about Teslas and the second computing device 110B may receive results 190B that includes information about 4Runners. However, in each case, the scrolling graphical user interface element displayed on each computing device will be automatically updated to include a Tesla item and a 4Runner item.

In some cases, the GUI generation system 160 may be configured to update the scrolling graphical user interface element with queries that were submitted by each individual (e.g., the scrolling graphical user interface element will be updated to include a Tesla item and a 4Runner item). In other cases, the GUI generation system may be configured to update the scrolling graphical user interface element with queries that were submitted by other individuals only (e.g., the scrolling graphical user interface element would not include a Tesla item on the computing device of the individual that submitted Tesla as the query).

Because the scrolling graphical user interface element provides information about queries that other individuals are providing to the query response system 140, the items in the scrolling graphical user interface element may pique the interest of the other individuals that access the query response system 140.

For example, the first individual that submitted query 120A of Tesla, may see the 4Runner item (that is associated with the query 120B submitted by the second individual that accessed the second computing device 110B) on the scrollable graphical user interface element. If the individual's interest is piqued, the individual may select the 4Runner item. In response to the selection, a query for “4Runner” is automatically provided to the query response system 140 in a similar manner that was described above. In some cases, the scrolling graphical user interface element may also be updated to include a new 4Runner item in a similar manner as was described above.

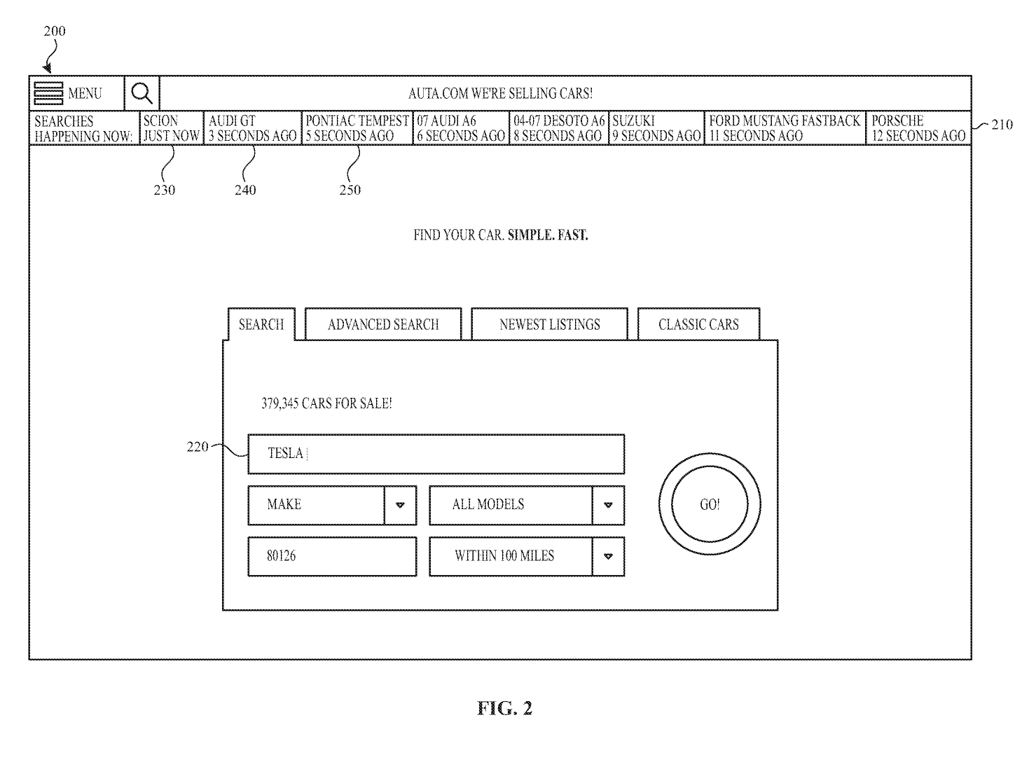

FIG. 2 illustrates an example user interface 200 of a webpage that includes a scrolling graphical user interface element 210. In this example, the user interface 200 is also configured to receive a query according to an example.

As shown in FIG. 2, the scrolling graphical user interface element 210 includes a number of different items 230-250. These items indicate queries that have been received from various individuals that accessed the website that displays the user interface 200. As shown, the scrolling graphical user interface element 210 includes a first item 230 that indicates that a query for “Scion” was submitted by a first individual. As also shown, the scrolling graphical user interface element 210 indicates that this query was received by the search system (or that a search for “Scion” was performed) “just now.” The scrolling graphical user interface element 210 also includes a second item 240 that indicates a query for an “Audi GT” was submitted and/or executed “3 seconds ago”.

Continuing with the example, the scrolling graphical user interface element 210 also includes a third item 250 that indicates that a query for a “Pontiac Tempest” was submitted to the search system from another individual (or the same individual) “5 seconds ago” and so on. In some cases, the graphical user interface element 210 is displayed on each computing device that accesses the user interface 200. In some cases, the is true regardless of whether the individual has submitted a query or not. Thus, an individual may see what queries are being executed in real time or substantially real time as the scrolling graphical user interface is automatically and continuously being updated with new items.

As discussed above and as will be explained in greater detail below, each of the items 230-250 that are displayed on the scrolling graphical user interface element 210 are selectable. As such, when an individual selects one of the items, a query using that item as a search term, will be performed.

The graphical user interface 200 also includes a text box 220 that enables an individual to input and submit a query. In this example, the individual has entered “Tesla”. The graphical user interface 200 may also include other text boxes in which additional information about a query may be provided.

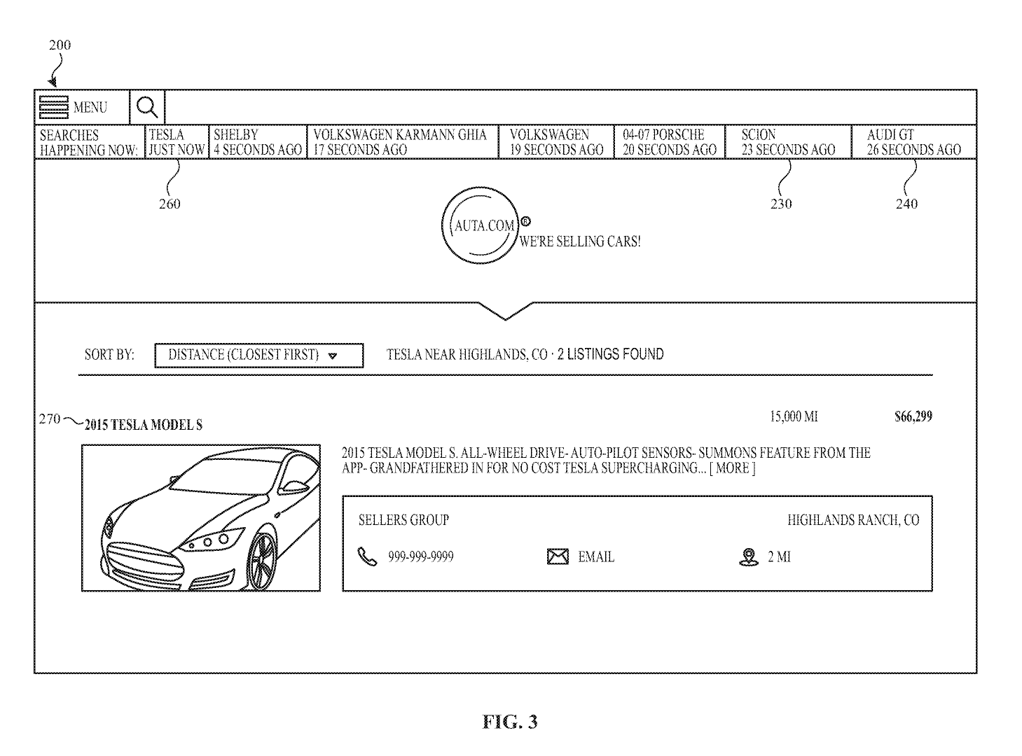

Once the individual submits the query, the scrolling graphical user interface element 210 is updated. For example and turning to FIG. 3, the scrolling graphical user interface element 210 now includes a “Tesla” item 260. As shown, the query for the Tesla was received and/or executed “just now.”

As also shown, the scrolling graphical user interface element 210 has caused the other displayed items to be moved in response to other queries that have been received and/or executed. For example, item 230 associated with the Scion query and item 240 associated with the Audi GT query have moved from one end of the scrolling graphical user interface element 210 to another. As also shown, item 250 associated with the Pontiac Tempest query is no longer displayed.

FIG. 3 also shows that the scrolling graphical user interface element 210 has been updated in real time or substantially real time to display additional items (e.g., a “Shelby” item, a “Volkswagen Karmann Ghia” item etc.) associated with received queries. The additional items also include or otherwise display a corresponding time frame in which those queries were received and/or executed.

As described above and shown in FIG. 3, the graphical user interface 200 may also display results 270 of a query. For example, in response to a query of Tesla, information about one or more Teslas may be displayed.

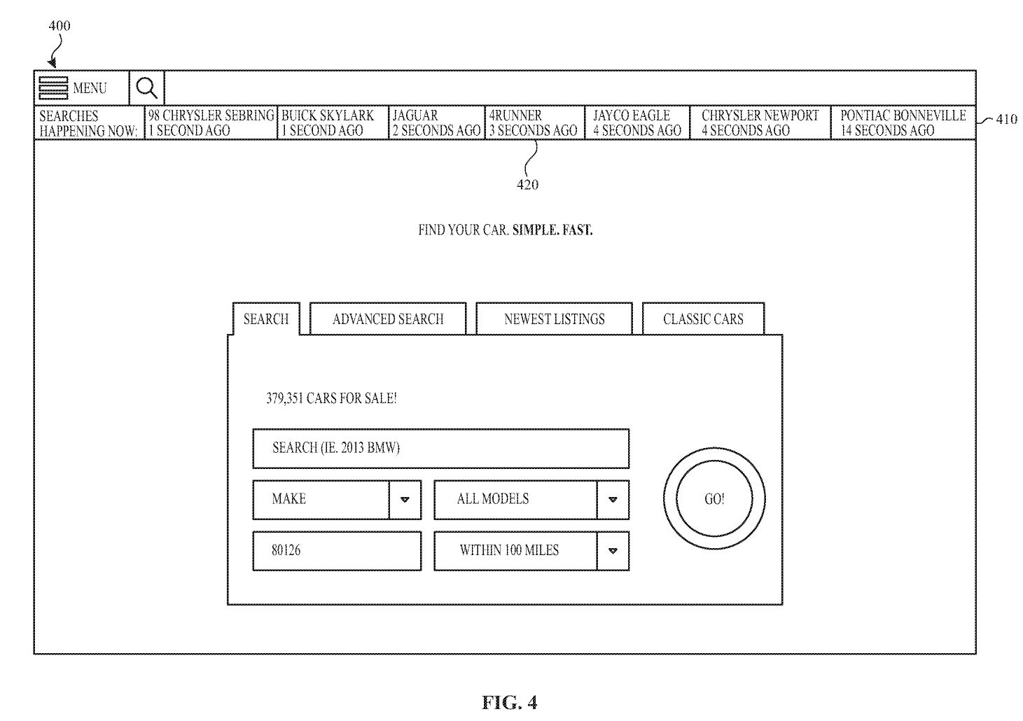

FIG. 4 illustrates another user interface 400 of a webpage that displays a scrolling graphical user interface element 410 according to an example. Like the scrolling graphical user interface element 210 described above, the scrolling graphical user interface element 410 functions in a similar manner. That is, the scrolling graphical user interface element 410 includes a number of different selectable items, such as, for example, selectable item 420, that display information about searches that have been performed on a particular website (or over the world wide web). In this example, the selectable item 420 relates to a query for a “4Runner”.

In this example, the graphical user interface 400 includes a number of other text fields that may be used to specify a query. However, in this example, an individual that accesses the website on which the graphical user interface 400 is displayed, selects item 420 in the scrolling graphical user interface element 410.

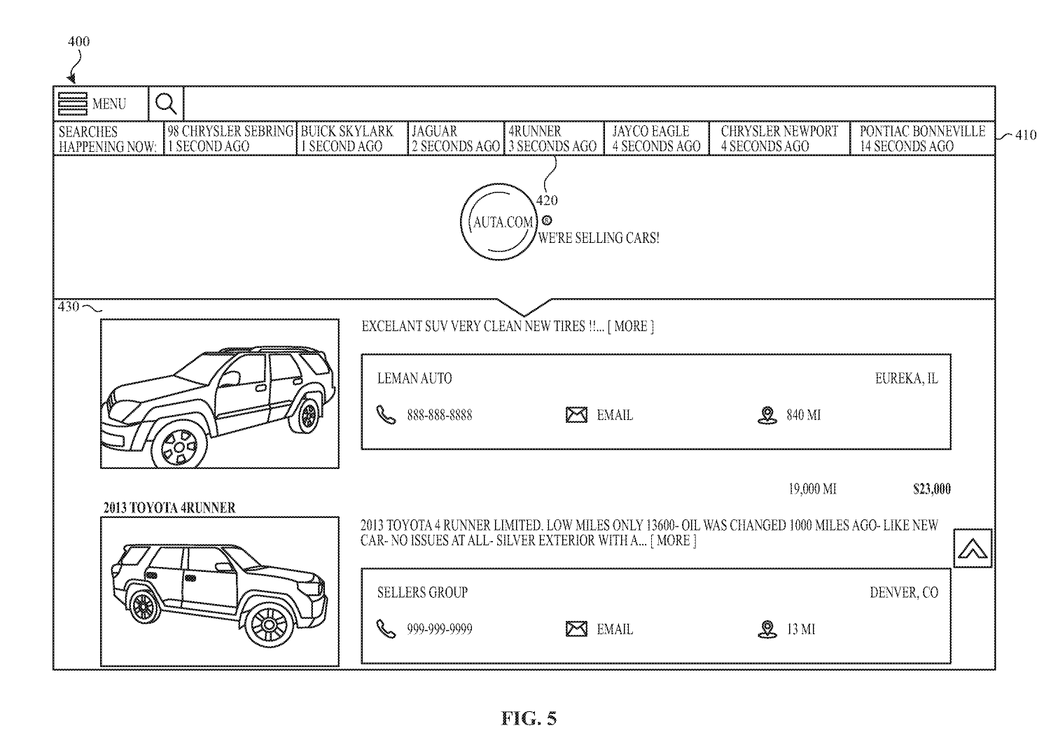

In response to this selection and turning to FIG. 5, a search is performed using information that was stored in a storage device and is associated with the originally submitted query of 4Runner. For example, when the 4Runner query was originally received, information about the query was stored in a storage device. When the item 420 was generated, the stored information was used to generate the item. Thus, when the item 420 is selected, this stored information may be used to execute the query. As shown in FIG. 5, in response to the selection of the item 420, the user interface 400 displays results 430 that show information about various 4Runners.

In some instances, the results 430 may be similar to the results that were displayed when the 4Runner query was originally submitted by the individual. In other cases, the results may be tailored based, at least in part, on known information about the individual that selected item 420. For example, if the individual that originally submitted the query for 4Runner lives in Minnesota and the individual that selected the item 420 lives in Colorado, the original query may return results in a geographic area associated with Minnesota (and/or return results based on other parameters that the individual specified) and selection of the item 420 may return results in a geographic area associated with Colorado. In other examples, selection of the item 420 may return all results regardless of geographic area and/or other parameters that were included in the original 4Runner query.

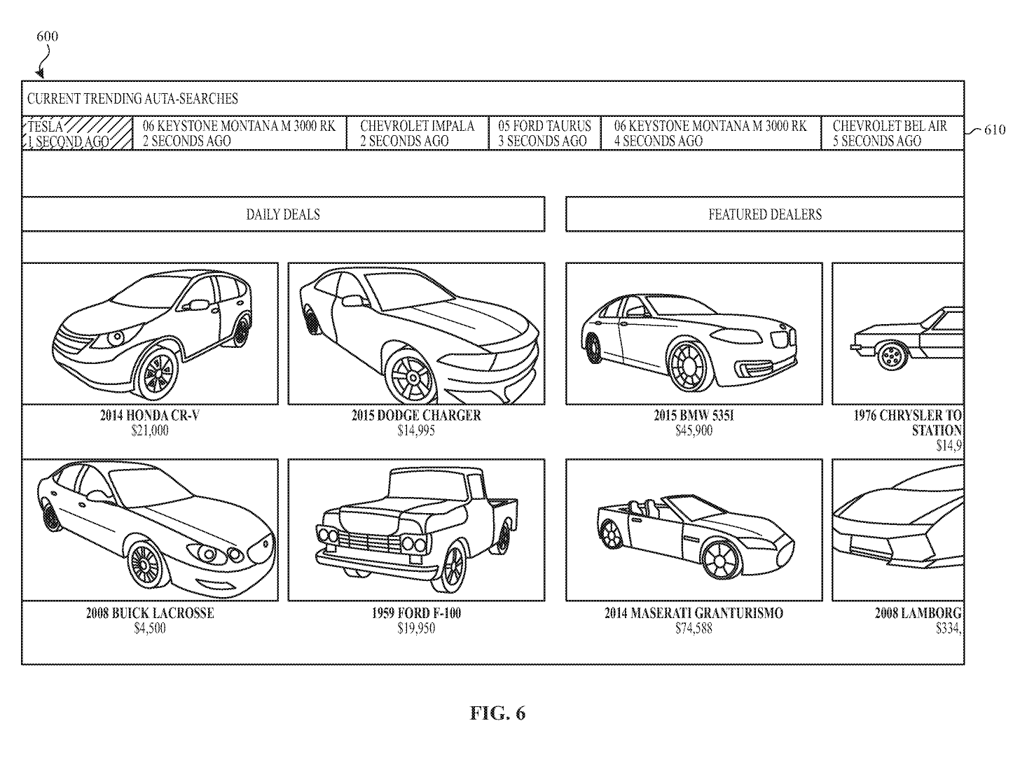

FIG. 6 illustrates another example of a scrolling graphical user interface element 610 that may be provided in a user interface 600 of a webpage according to an example. Like the scrolling graphical user interface elements described above, the scrolling graphical user interface element 610 may include a number of selectable items. In some cases, different portions of the scrolling graphical user interface element 610 may be color coded or displayed differently when a new search is submitted to the system. For example, when a new query is submitted, the first item in the scrolling graphical user interface element 610 may be red while the other items are black. In other examples and as shown in FIG. 6, a newly executed search may be spaced apart or otherwise be separated from older items.

In yet other examples, items in the scrolling graphical user interface element 610 that are associated with queries that are trending or have been popular over a specified period of time (e.g., the last hour, the last day, the last week, etc.) may be color coded or otherwise have an indication, marking, icon etc., that allows individuals to determine the popularity of specific items or topics. In such examples, the scrolling graphical user interface element 610 and/or the colors or other such indications may serve to pique people's interest in that particular query but may also serve as a notification to other individuals (e.g., sellers and/or providers of those items) that individuals are actively looking for particular items.

For example, if an individual submits a query for a 4Runner, a dealership that has a number of 4Runners for sale may learn, by watching the items on the scrolling graphical user interface element, that 4Runners are currently trending. As such, the dealership may decide to advertise with website that displays the user interface 600.

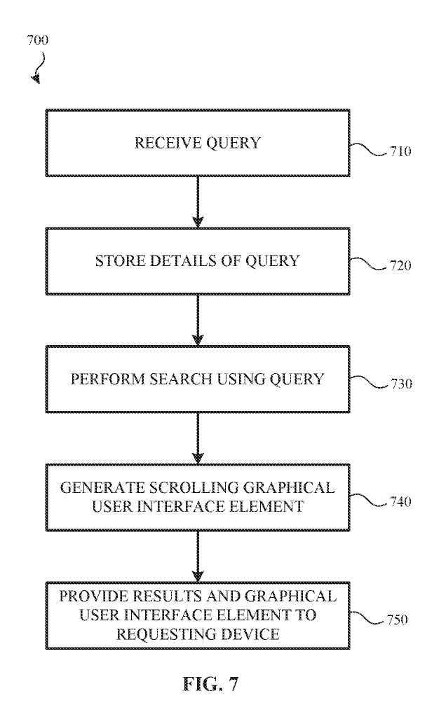

FIG. 7 illustrates a method 700 for generating a scrolling graphical user interface element according to an example. In some examples, method 700 may be used to generate the scrolling graphical user interface element 210, the scrolling graphical user interface element 410 and the scrolling graphical user interface element 610 described herein.

Method 700 begins at operation 710 in which a query is received. The query may be received by an individual that accesses a user interface on a webpage, application, or other type of user interface on a computing device.

Once the query is received, flow proceeds to operation 720 and one or more details of the query are stored. For example, once the query is provided in a text box and submitted to a query response system, information about the query is determined and stored. In some cases, the information may include one or more search terms associated with the query. In other cases, the information may include one or more parameters associated with the query. For example, if the query is for automobiles, the one or more parameters may include price, a year, mileage, location and so on.

Once the details of the query have been stored, flow proceeds to operation 730 and a search is performed using the information associated with the query. In some cases, the search may be executed on a database that is only accessible to the website in which the query was submitted. In other examples, the search may be performed over the world wide web.

In operation 740, a scrolling graphical user interface element is generated. In some cases, operation 740 includes generating one or more items for a scrolling graphical user interface element and updating the graphical user interface element with the new item in real time or substantially real time. In other examples, operation 740 causes the scrolling graphical user interface element to be created with the new item.

As discussed above, the item may be associated with the received query and be created with information that was stored in operation 720. The item may also be selectable. As such, when the item is selected, a query may be performed using the information that was included in the originally submitted query (e.g., the query that was received in operation 710). In some cases, the item may include other information such as, for example, when the query was received and/or when the search was executed, a popularity of query, and so on.

Flow then proceeds to operation 750 and the results of the query, along with the scrolling graphical user interface element and its associated items, are provided to the computing device from which the query is received.

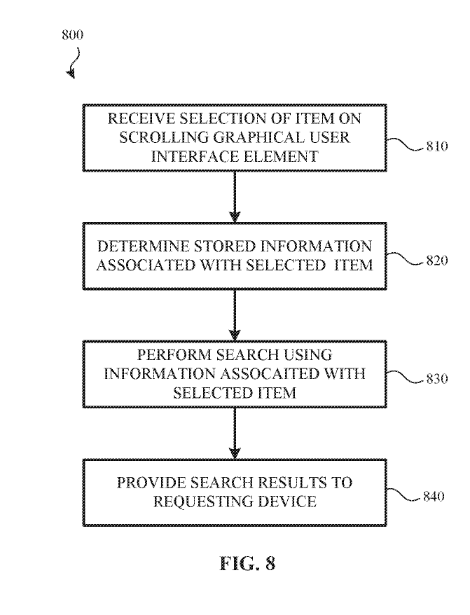

FIG. 8 illustrates a method 800 for performing a search in response to received input in a scrolling graphical user interface element. In some cases, the method 800 may be performed when an item, such as, for example, item 420 (FIG. 4) in a scrolling graphical user interface element (e.g., scrolling graphical user interface element 410) is selected.

Method 800 begins in operation 810 in which an item in a scrolling graphical user interface element is selected. In some cases, an individual may access a website on which the scrolling graphical user interface element is displayed and select one or more of the items. As discussed above, each of the items in the scrolling graphical user interface element is associated with one or more queries that have been received by a website, a search engine, an application and so on.

Flow then proceeds to operation 820 and the stored information about the selected items is determined. For example, if the selected item is associated with a query for 4Runners, information about the query (e.g., search terms, year, geographic location, mileage, transmission etc.) may be determined. In some cases, this information may be used when a query is ultimately submitted (e.g., in operation 830). In other cases, some or all of the information may be discarded when the query is submitted.

Flow then proceeds to operation 830 and a query is performed using the information associated with the item. Continuing with the example from above, if the item is associated with a query for a 4Runner, a query for 4Runners is performed. As discussed above, the query may be performed using the same context and/or other information that was included with the original query. In other cases, some or all of the information may be discarded and a general search for the item (e.g., 4Runners) may be executed.

In operation 840, search results and provided to the device on which the item in the scrolling graphical user interface element was selected. In some cases, the scrolling graphical user interface element may also be updated to indicate that the item was selected and a query was performed. For example, the scrolling graphical user interface element may be updated to indicate that a search for 4Runner was recently executed.

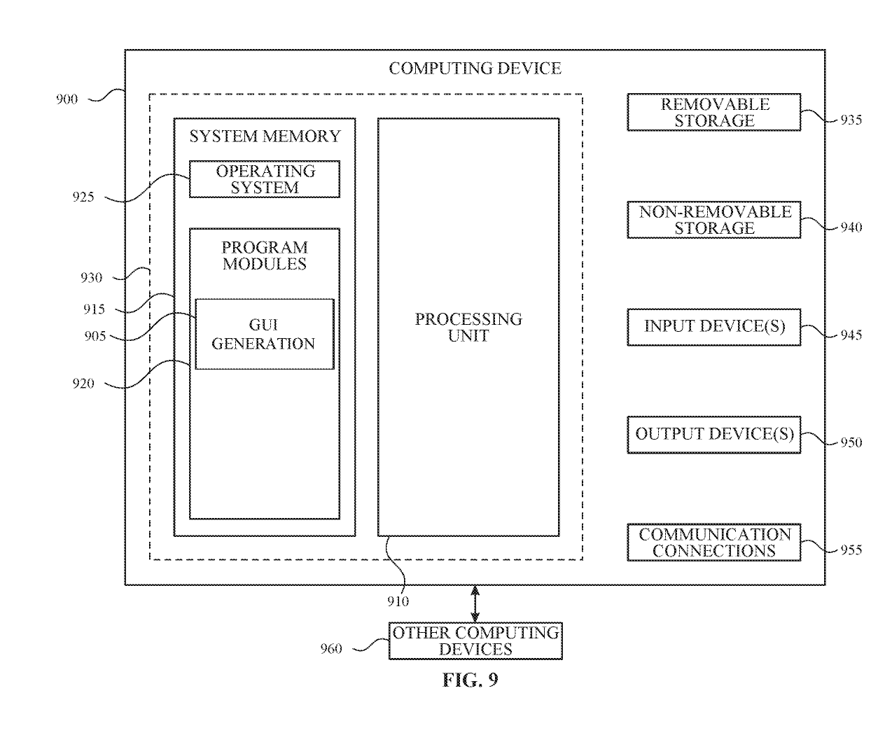

FIG. 9 is a block diagram illustrating physical components (e.g., hardware) of a computing device 900 with which aspects of the disclosure may be practiced. The computing device 900 may be similar to the computing devices described above with respect to FIG. 1A and FIG. 1B. The components of the computing device 900 described below may have computer executable instructions for automatically generating a scrolling graphical user interface element and/or automatically performing search when an item in the scrolling graphical user interface element is selected such as described above.

In a basic configuration, the computing device 900 may include at least one processing unit 910 and a system memory 915. Depending on the configuration and type of computing device, the system memory 915 may comprise, but is not limited to, volatile storage (e.g., random access memory), non-volatile storage (e.g., read-only memory), flash memory, or any combination of such memories. The system memory 915 may include an operating system 925 and one or more program modules 920 or components suitable for identifying various objects contained within captured images such as described herein.

The operating system 925, for example, may be suitable for controlling the operation of the computing device 900. Furthermore, examples of the disclosure may be practiced in conjunction with a graphics library, other operating systems, or any other application program and is not limited to any particular application or system. This basic configuration is illustrated in FIG. 9 by those components within a dashed line 930.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 935 and a non-removable storage device 940.

As stated above, a number of program modules and data files may be stored in the system memory 915. While executing on the processing unit 910, the program modules 920 (e.g., a GUI Generation system 905 that may include one or more of the various systems described above with respect to FIG. 1A and FIG. 1B) may perform processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 900 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general purpose computer or in any other circuits or systems.

The computing device 900 may also have one or more input device(s) 945 such as a keyboard, a trackpad, a mouse, a pen, a sound or voice input device, a touch, force and/or swipe input device, etc. The output device(s) 950 such as a display, speakers, a printer, etc. may also be included. The aforementioned devices are examples and others may be used. The computing device 900 may include one or more communication connections 955 allowing communications with other computing devices 960. Examples of suitable communication connections 955 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 915, the removable storage device 935, and the non-removable storage device 940 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving, in a search box associated with a webpage, input corresponding to a query to be performed;
storing one or more details associated with the query;
performing a search using the received input to determine a result of the query;
generating a scrolling graphical user interface element that displays, in substantially real time, an item associated with the input along with one or more additional items that are each associated with one or more other received query requests; and
providing the result of the query and the scrolling graphical user interface element in a graphical user interface of the webpage.

2. The method of claim 1, wherein the scrolling graphical user interface element includes a time indicator that displays an amount of time that has passed since the query was requested.

3. The method of claim 2, further comprising updating the amount of time in substantially real time.

4. The method of claim 1, wherein the scrolling graphical user interface element includes a time indicator that displays an amount of time that has passed since the search was performed.

5. The method of claim 4, further comprising updating the amount of time in substantially real time.

6. The method of claim 1, wherein the one or more additional items are associated with queries that are received from one or more computing devices that are different than a computing device that provided the input corresponding to the query.

7. The method of claim 1, wherein the item on the scrolling graphical user interface is selectable.

8. The method of claim 7, further comprising performing a search using information associated with the item when the item on the scrolling graphical user interface has been selected.

9. The method of claim 1, wherein each of the one or more additional items that are associated with the one or more other query requests are selectable.

10. The method of claim 9, further comprising performing a search using information associated with a selected one of the one or more additional items.

11. A system, comprising:
a processing unit; and
a memory for storing instructions that, when executed by the processing unit, perform a method, comprising:
receiving input corresponding to a query to be performed;
storing one or more details of the query;
performing a search using the received input to determine a result of the query;
generating a scrolling graphical user interface element that displays, in substantially real time, a selectable item that is associated with the input, along with one or more additional selectable items, wherein each of the one or more additional selectable items are associated with one or more other received query requests, wherein the selectable item is also associated with the one or more details of the query; and
providing the result of the query and the scrolling graphical user interface element in a graphical user interface of a webpage.

12. The system of claim 1, wherein the scrolling graphical user interface element includes a time indicator that displays an amount of time that has passed since the query was requested.

13. The system of claim 12, further comprising instructions for updating the amount of time in substantially real time.

14. The system of claim 11, wherein the scrolling graphical user interface element includes a time indicator that displays an amount of time that has passed since the search was performed.

15. The system of claim 14, further comprising instructions for updating the amount of time in substantially real time.

16. The system of claim 11, wherein the one or more other received query requests are received from one or more computing devices that are different than a computing device that provided the input corresponding to the query.

17. The system of claim 11, further comprising instructions for performing a search using the one or more details of the query when the selectable item is selected.

18. The system of claim 11, further comprising instructions for performing a search using one or more stored details associated with the one or more additional selectable items when at least one of the one or more additional selectable items is selected.

19. A user interface for a computing device, comprising:
an input field for receiving one or more details of a query to be executed on a database of stored information;
a results field that displays one or more results of the query that was executed on the database of stored information; and
a scrolling graphical user interface element that displays, in substantially real time, a plurality of selectable items, wherein each of the plurality of selectable items are associated with one or more other queries that were received from one or more other computing devices, the one or more other queries having been executed on one or more databases of stored information.

20. The user interface of claim 19, wherein each of the plurality of selectable items is associated with a counter that displays an amount of time that has passed since the one or more queries were received.
